(19) United States
(12) Patent Application Publication
(10) Pub. No.: US 2011/0075123 A1
(43) Pub. Date: Mar. 31, 2011

(54) Method for detecting work alignment mark and exposure apparatus using the same

(75) Inventor: Shinichi Nagamori, Shizuoka (JP)

(73) Assignee: USHIO DENKI KABUSHIKI KAISHA, Tokyo (JP)

(21) Appl. No.: 12/923,329

(22) Filed: Sep. 15, 2010

(30) Foreign Application Priority Data
Sep. 17, 2009 (JP) 2009-215305

(51) Int. Cl. G03B 27/58; G01B 11/02

(52) U.S. Cl. 355/72; 356/399

(57) ABSTRACT

In a method of detecting a workpiece alignment mark for positioning a mask and a workpiece or in an exposure apparatus, a control unit detects a pattern whose positional relationship is determined with respect to the workpiece mark at a low magnification. The pattern is larger than the workpiece mark, and/or the pattern has a high contrast to include a large amount information (a search mark). When the magnification of the microscope is switched to a high magnification, the workpiece is moved to a position where the workpiece mark is within a view of the microscope, according to the positional relationship. Subsequently, the workpiece mark position is detected at the high magnification.

### CROSS-REFERENCES TO RELATED APPLICATION

This application claims priority from Japanese Patent Application Serial No. 2009-215305 filed Sep. 17, 2009, the contents of which are incorporated herein by reference in their entirety.

### TECHNICAL FIELD

The present invention relates to a method for detecting a workpiece alignment mark for position alignment (method) in which a mask alignment mark formed on a mask and the workpiece alignment mark formed on a workpiece are detected, and both are positioned (aligned) so as to be in a predetermined position relation, and an exposure apparatus using the method for detecting a work alignment mark. Especially, the present invention relates to a method for detecting a workpiece alignment mark, which is suitable for a case where a transparent pattern formed on a transparent workpiece is used as a workpiece alignment mark, and an exposure apparatus using the same.

### BACKGROUND

An exposure apparatus is used in a process of forming, by a photo-lithography, a pattern (s) on a semiconductor device, a printed circuit board, a liquid crystal substrate, etc. The exposure apparatus aligns a mask that has a pattern, which is transferred to a workpiece, with the workpiece to be in a predetermined positional relationship, and then irradiates the workpiece through the mask with light containing exposing light, whereby the pattern of the mask is transferred (exposed) to the workpiece. Generally, in the exposure apparatus, the alignment of the mask and the workpiece is performed as set forth below. An alignment microscope(s) detects a mask alignment mark(s) (hereinafter referred to as a mask mark) formed in the mask, and a workpiece alignment mark(s) (hereinafter referred to as a workpiece mark) formed on the workpiece. Image processing of data of the detected mask mark(s) and the workpiece mark(s) is performed, in order to detect the position coordinate of each mark, and the mask and/or the workpiece is moved so that both marks are in pre-set positional relationship. The mask and the workpiece must be aligned with each other with respect to two directions (X and Y) on a plane, and a rotational direction (θ). Therefore, the mask marks and the workpiece marks are respectively formed at two or more positions.

FIG. 5 shows a schematic structure of an alignment microscope 10 that detects a workpiece mark. In addition, as described above, since the mask marks and the workpiece marks are respectively formed at the two or more positions, so that alignment microscopes 10 are also provided at two or more places so as to correspond to the mask marks and the workpiece marks, but the figure shows only one of them (one position). The alignment microscope 10 is equipped with a first CCD camera 13 that detects a three times magnification image, a second CCD camera 14 that detects a ten times magnification image, lenses L1-L4, and half mirrors 10a, 10b, and 10c. A workpiece mark WAM is formed on a workpiece W. A control unit 11 carries out image processing, which the CCD cameras 13 and 14 receive, and then obtains and stores the positional information of the mask mark (s) MAM and the positional information of the workpiece mark (s) WAM. Then, the control unit 11 moves a workpiece stage WS so that the position of the mask mark (s) MAM and workpiece mark (s) WAM may be in agreement. A monitor 12 is used, when an operator registers and stores the mask mark (s) MAM and the workpiece mark (s) WAM in the control unit 11. Moreover, the operator can also visually check the state of the alignment operation. As shown in FIG. 5, Japanese Patent Application Publication No. 2000-147795 teaches an alignment microscope equipped with two detectors having different magnifications.

Next, description of an operation for detecting the workpiece mark WAM by the alignment microscope 10 will be given below referring to FIGS. 5 and 6. For the operation, pattern images of the workpiece mark (s) WAM to be detected are stored (registered) in the control unit 11 in advance. Two kinds of pattern images, that is, a pattern image detected at three times magnification and a pattern image detected at ten times magnification, are registered as the pattern images of the workpiece mark (s) WAM, so as to correspond to the magnifications of the alignment microscope 10. Specifically, the operator visually finds the work mark (s) WAM in a three times magnification image of the workpiece W displayed on the monitor 12, and registers the pattern image as a pattern image detected at the three times magnification. Next, the operator visually finds the work mark(s) WAM in a ten times magnification image of the workpiece W displayed on the monitor 12, and registers the pattern image as a pattern image detected at the ten times magnification. In addition, the three times magnification view is larger in surface area than the ten times magnification view. When the workpiece W, on which exposure processing is actually performed, is transported onto the workpiece stage WS, the workpiece mark WAM of the workpiece W and an area R that is a circumference area thereof (an area where the workpiece mark may exists) are irradiated with irradiation light for detecting the workpiece mark WAM. The irradiation light that passes through the half mirror 10a of the alignment microscope 10 is emitted thereto.

The light, with which the area R is illuminated, is reflected on a surface of the workpiece W, enters the alignment microscope 10, is reflected by the half mirror 10a, passes through the lens L1, and is bifurcated (two branched) by the half mirror 10b. Part of the light (a light component), which is bifurcated by the half mirror 10b, passes through the lens L2 and enters the first CCD camera 13. As a result, the first CCD camera 13 receives a three times magnification image of the area R. On the other hand, the other part of light, which is bifurcated by the half mirror 10b, passes through the lens L3, is reflected by the half mirror 10c, passes through the lens L4, and enters the second CCD camera 14. As a result, the second CCD camera 14 receives a ten times magnification image of the area R. Subsequently, when the images of the area R are received by the first CCD camera 13 and the second CCD camera 14, they are sent to the control unit 11.

The control unit 11 searches and matches the pattern received by the first CCD camera 13 with the registered three times magnification pattern image of the workpiece mark WAM, that is, the control unit 11 searches for the workpiece mark WAM (refer to FIG. 6A). Even if the position thereof shifts slightly when the workpiece W is transported onto the workpiece stage by a conveyance apparatus, the workpiece mark WAM can be searched because the three times magnification image includes a wide view. When the workpiece mark WAM is detected by using the three times magnification image, the control unit 11 moves the workpiece W (the workpiece stage) so that the position of the detected workpiece mark WAM is located at the center of the view of the alignment microscope 10 (refer to FIG. 6B). Then, the control unit 11 switches the image of the area R, which the alignment microscope 10 receives, to the ten times magnification image, which is received by the second CCD camera 14, whereby an image of a center portion of the area R is enlarged ten times. (refer to FIG. 6C).

Since the workpiece mark WAM has been moved to the center of the view of the alignment microscope 10 as described above, the workpiece mark WAM and its circumference area are enlarged in fact. The control unit 11 searches and matches the pattern received by the 2^{nd} CCD camera 14 with the registered ten times workpiece mark WAM pattern, that is, the control unit 11 searches the workpiece mark WAM. When the workpiece mark WAM is detected, the workpiece mark WAM is aligned with the mask mark MAM based on the position information of the ten times magnification workpiece mark WAM image. In addition, for example, Japanese Patent Application Serial No. H09-82615 teaches such a method of detecting a mask mark.

The reason for detecting the workpiece mark WAM by switching the magnification of the alignment microscope 10 at low magnification (three times) to high magnification (ten times) is that although high magnification alignment microscope is required in order to align the mask and the workpiece with a high degree of accuracy, if the detection is carried out with only the high magnification thereof, the workpiece mark may be out of the view of the alignment microscope 10 so that the alignment may not be performed due to a conveyance error at time of transporting the workpiece to the workpiece stage, and/or an error of at a workpiece mark formation that is a previous stage. Therefore, as described above, the two alignment steps are performed, that is, the first alignment step, in which the workpiece mark is placed within the high magnification view by using a wide view at the low magnification, which may not be out of view thereof even though there are the above described errors, and a second alignment step in which a second alignment is carried out at the high magnification.

### SUMMARY

In view of the above, the present invention pertains to a method of alignment by detecting, by an alignment microscope, a mask alignment mark formed on a mask and a workpiece alignment mark formed on a workpiece and aligning a mask and a workpiece based on the detected mask alignment mark and workpiece alignment mark. The method comprises detecting a search mark formed on the workpiece by using a first magnification; moving a workpiece stage so that the workpiece alignment mark, which is in a predetermined relative position to a position of the detected search mark, comes within a second magnification view of the alignment microscope; switching magnification between the first magnification and a second magnification, which is higher than the first magnification; and detecting the workpiece alignment mark by using the second magnification.

In the method of alignment, the size of the pattern of the search mark on the workpiece may be larger than that of the pattern of the workpiece alignment mark on the workpiece.

In the method of alignment, material that forms the search mark on the workpiece may be different from that which forms the workpiece alignment mark on the workpiece.

In the method of alignment, the workpiece may transmit visible light, and the search mark may be formed of an opaque pattern which is formed on the transparent workpiece, and the workpiece alignment mark may be a transparent pattern which is formed on the transparent workpiece.

An exposure apparatus that comprises a light emitting unit that emits exposure light; a pattern formed in a mask; a mask stage holding the mask; a workpiece that is irradiated with the exposure light emitted from the light emitting unit through the mask; a workpiece stage holding the workpiece; an alignment microscope that detects a mask alignment mark formed on the mask and a workpiece alignment mark formed on the workpiece; and a control unit that performs alignment of the mask and the workpiece based on a position information of the detected mask alignment mark and a workpiece alignment mark. The exposure apparatus's alignment microscope is capable of switching magnification between a first magnification and a second magnification that is higher than the first magnification.

The exposure apparatus's control unit comprises a storage unit that stores a pattern of a search mark formed on the workpiece and a pattern of the workpiece alignment mark, and an image processing unit that detects the search mark on the workpiece and the workpiece alignment mark by comparing the patterns of the search mark on the workpiece and the workpiece alignment mark, which were both observed by the alignment microscope, with the patterns of the search mark and the workpiece alignment mark that are stored in the storage unit. The control unit switches the magnification of the alignment microscope to the first magnification, detects the search mark formed on the workpiece, moves the workpiece stage so that the workpiece alignment mark that is in predetermined relative position with respect to a position of the detected search mark comes in a second magnification view of the alignment microscope, switches the magnification of the alignment microscope to the second magnification, and detects the workpiece alignment mark at the second magnification.

According to the present invention, the “detection” means an operation of finding a workpiece alignment mark to obtain a position coordinate.

### BRIEF DESCRIPTION OF THE DRAWINGS

Other features and advantages of the present method for detecting a work alignment mark and the present exposure apparatus using the same will be apparent from the ensuing description, taken in conjunction with the accompanying drawings, in which:

FIG. 1 is a diagram showing a configuration example of a projection exposure apparatus to which the present invention can be applied;

FIGS. 2A and 2B are diagrams showing an example of an image displayed on a monitor 12 by an alignment microscope 10;

FIGS. 3A and 3B are diagrams explaining about an amount of movement in a case of moving a workpiece stage WS so that a workpiece mark WAM may be within an image thereof;

FIGS. 4A, 4B, and 4C are diagrams showing an example in the case where an alignment microscope detects a transparent electrode formed on a transparent glass substrate;

FIG. 5 is a diagram of a related art showing a schematic structure of an alignment microscope that detects a workpiece mark;

FIGS. 6A, 6B, and 6C are explanatory diagrams showing steps of detecting a workpiece mark by changing magnification of an alignment microscope;

FIG. 7A is a diagram showing an example of a workpiece mark image detected at three times magnification;

FIG. 7B is a diagram showing an example of a workpiece mark image detected at ten times magnification; and

FIGS. 8A, 8B, and 8C are diagrams explaining problems in case where an alignment microscope detects a workpiece mark at low magnification.

### DESCRIPTION

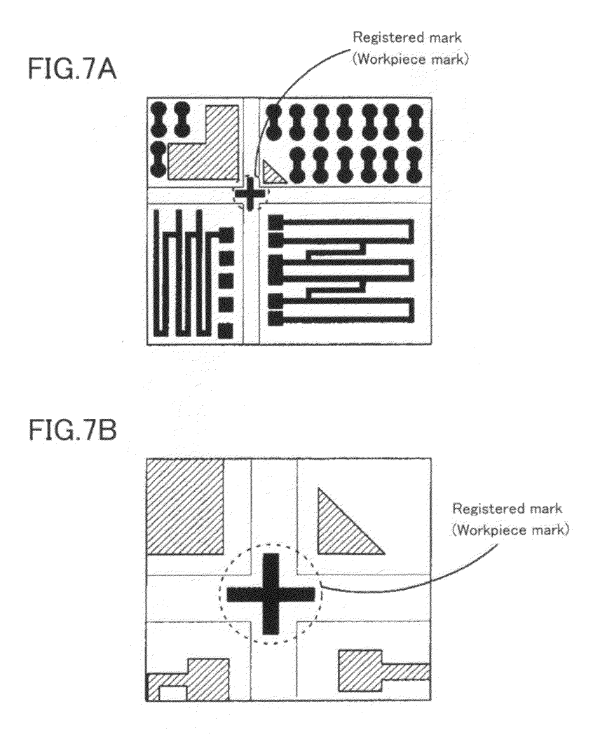

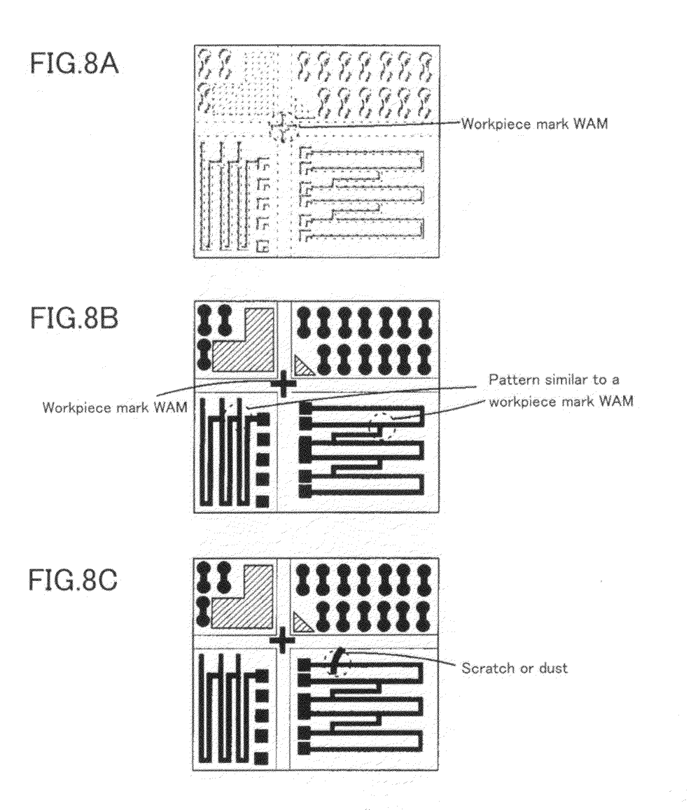

Detection of a workpiece mark, which is performed by an alignment microscope, is carried out, by changing the magnification of the microscope in two steps, as described above. Simply put, as shown in FIG. 7A, the workpiece mark is searched in an area where the workpiece mark should exist at a low magnification (three times magnification), and then, as shown in FIG. 7B, the workpiece mark is aligned at high magnification (ten times magnification). However, since the workpiece mark is originally formed so as to be able to perform alignment with a high degree of accuracy when the workpiece mark is detected at high magnification (ten times), the workpiece mark, which is seen, looks small at the low magnification (three times), and the amount of the information as to an image thereof is small. Because of the above situation, problems set forth below were found. The amount of information as to an image of the workpiece mark WAM becomes less, when it is very difficult to find the workpiece mark WAM since, for example, a resist, which is hard to transmit irradiation light, is applied thickly on the pattern of the workpiece, or a pattern is a transparent electrode formed on a transparent glass substrate and the workpiece mark WAM is also transparent. FIG. 8A is a schematic view showing an image of a pattern whose contrast is low, wherein the pattern, which is hard to be seen, is shown by a dotted line, and a cross shape surrounded by the dotted line is the workpiece mark WAM.

As described above, the detection of the workpiece mark WAM is performed by finding the pattern, which is matched with the stored pattern, in an actual image of the wafer. Here, the control unit judges whether the stored pattern image is matched with the pattern in the image, based on a degree of matching of the image information thereof. The control unit is configured so that, for example, “when more than 80% of the image information of the stored pattern, is matched with the image pattern of the workpiece, it is detected as the workpiece mark”. When an amount of information as to the image of the workpiece mark WAM in the image of the workpiece is small, even if the workpiece mark WAM exists in the image, the image of the stored pattern and the image of the workpiece mark WAM, are not matched and the workpiece mark WAM cannot be detected. In order to avoid this problem, the matching degree is lowered, for example, “the workpiece mark is detected when the degree of matching is 40%”, as shown in FIG. 8B, other patterns (a pattern encircled with a dotted line in the figure) that are similar to the stored pattern image of the workpiece mark are falsely detected as the workpiece mark. Moreover, as shown in FIG. 8C, when scratches are produced on and/or dusts adheres to the workpiece an overlap with the workpiece pattern forms therebelow, so that, by chance, patterns similar to the workpiece mark are formed (refer to a portion encircled with dotted lines in the figure), and may be detected as the workpiece mark.

It may be considered that as a method of solving these problems, an image of the workpiece mark is enlarged so as to increase the amount of image information. However, in such a case, when the workpiece mark is detected at high magnification (ten times), the workpiece mark may not be within the ten times magnification view so that it is impossible to detect the workpiece mark.

The present invention is made in order to solve the above problems. It is an object of the present invention to certainly detect a workpiece mark without any error when a workpiece mark is found at low magnification, and highly accurate alignment is performed at high magnification, by using an alignment microscope, even if the contrast of an image of a pattern formed on the workpiece is low.

In the present invention, a pattern that is detected by using low magnification, may be different from the workpiece mark, which is detected by using high magnification. In a control unit, it is possible to store two patterns, that is, a pattern detected by using the low magnification and a pattern detected by using the high magnification. The pattern detected by using the low magnification is larger or has a higher contrast than the workpiece mark, and it is seen clearly at the low magnification, that is, the pattern includes more image information and a unique shape, and the pattern, whose positional relationship is determined with respect to the workpiece mark, is used. Hereafter, this pattern is also referred to as a search mark. First, the control unit detects a pattern whose positional relationship is determined with respect to the workpiece mark at low magnification, (for example, a positional relationship between the pattern and the workpiece mark is determined, or a positional relationship is found beforehand, etc.), wherein the pattern is larger than the workpiece mark, and/or the pattern has a high contrast so that a large amount information (a search mark) is included. And when the magnification of the microscope is switched to high magnification, the workpiece is moved to a position where the workpiece mark is within a view of the microscope, according to the positional relationship. After that, the position of the workpiece mark is detected at high magnification.

Thus, the pattern whose position is known with respect to the workpiece mark (workpiece alignment mark), and which is large and/or high in contrast even at the low magnification, is used as the pattern detected by using the low magnification. Since the pattern is seen clearly even at the low magnification, the amount of information as to an image thereof becomes large, the stored pattern and the pattern in the image can be matched with each other at a high degree so that it is possible to certainly detect the pattern without a false detection. And since the position of the pattern is known with respect to the workpiece mark, when switching to the high magnification, it is possible to move the workpiece to the position where the workpiece mark is within the view of the microscope so that the position of the workpiece mark can be detected at the high magnification. Since the workpiece mark looks large when it is seen at the high magnification, even if the contrast is somewhat low, the amount of information as to an image becomes larger than that at time of the low magnification. For this reason, the workpiece mark can be detected with certainty alignment started, and even if the contrast of the image of the pattern formed on the workpiece is low, it is possible to detect the pattern without a false detection.

When the size of the pattern of the search mark on the workpiece is made larger than that of the pattern of the workpiece alignment mark on the workpiece, or when the material which forms the search mark on the workpiece is different from the material which forms the workpiece alignment mark on the workpiece, even if the workpiece mark is hardly found, the search mark can be detected certainly, and the workpiece can be moved so as to be within the view of the microscope.

When the workpiece transmits visible light, and the workpiece mark, which is formed on the transparent workpiece, is a transparent pattern, by using the search mark which is a opaque pattern formed on the transparent workpiece, even if the workpiece mark is the transparent pattern which is formed on the transparent substrate, it is possible to certainly detect the pattern.

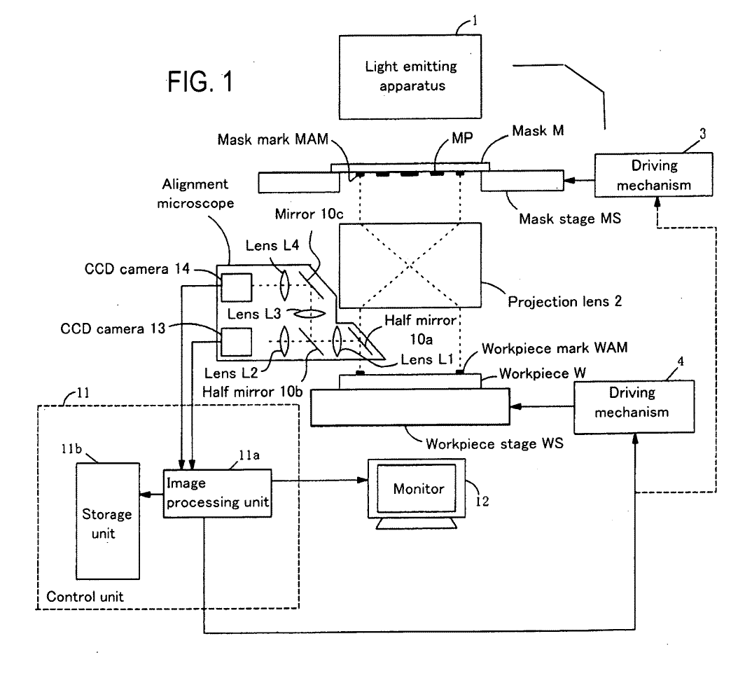

Next is a description of the present invention involving the figures. FIG. 1 is a diagram showing a structure of a projection exposure apparatus to which is a present invention is applied. A mask M in which a mask mark MAM and a mask pattern MP are formed, is placed and held on the mask stage MS. Exposure light is emitted from a light emitting apparatus 1. A workpiece W, which is placed on a workpiece stage WS, is irradiated with the emitted exposure light through the mask M and a projection lens 2, so that the mask pattern MP is projected and exposed on the workpiece W. Alignment microscopes 10 that can be moved in a direction of an arrow shown in the figure are provided between the projection lens 2 and the workpiece W at two places. Before the mask pattern MP is exposed to the workpiece W, the alignment microscope (s) 10 is inserted in the position shown in the figure, and the mask mark MAM and the workpiece mark WAM that is formed on the workpiece, are detected, thereby aligning the mask mark M and the workpiece W with each other. After the alignment, the microscope (s) 10 is retracted from the workpiece W. In addition, only one of the alignment microscopes, which are provided at two places, is shown in FIG. 1. As described above, each alignment microscope 10 has half mirrors 10a and 10b, lenses L1-L4, a mirror 10c, a three times magnification CCD camera 13, and a ten times magnification CCD camera 14.

In FIG. 1, the mask M and the workpiece W are aligned, as described below. The mask M is irradiated with irradiation light from the light emitting apparatus 1 or an alignment light source (not shown in the figure), and a mask mark MAM image is received by the CCD cameras 13 and 14 of the alignment microscope 10, and is sent to a control unit 11. An image processing unit 11a of the control unit 11 converts the mask mark MAM image into a position coordinate, and stores it in a storage unit 11b. In addition, for a method for detecting a mask mark, refer to, for example, Japanese Patent Application Serial No. H09-82615. Next, the workpiece W is irradiated with irradiation light, and the workpiece mark WAM on the workpiece W is detected, so that the control unit 11 obtains the position coordinate thereof. The control unit 11 moves the workpiece stage WS (or the mask stage MS or the both) so that the position coordinate of the stored mask mark MAM and that of the detected workpiece mark WAM may be in a predetermined positional relationship, whereby the mask M and the workpiece W are aligned with each other.

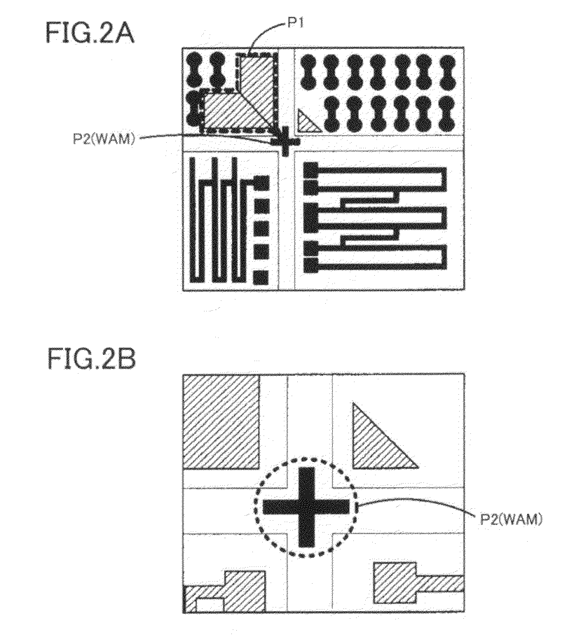

The procedure of detection of the workpiece mark in the exposure apparatus will be concretely described, referring to FIGS. 1, 2A, and 2B. FIGS. 2A and 2B are diagrams showing an example of an image displayed on a monitor 12 from an alignment microscope 10. Specifically, FIG. 2A shows a three times magnification image displayed thereon, and FIG. 2B shows a ten times magnification image displayed thereon. First, a pattern detected at time of low magnification (three times) and a pattern detected at time of high magnification (ten times), (that is, the workpiece mark WAM), are stored in the storage unit 11b of the control unit 11. An operator performs this registration visually, as described below. The actual workpiece W is placed on the workpiece stage WS, and a surface of the workpiece W is displayed on the monitor 12 (refer to FIG. 2A) by using three times magnification of the alignment microscope 10.

The operator looks at the displayed image of the workpiece W, and searches a pattern, which is in a predetermined positional relationship with respect to the workpiece mark (a cross shape shown in the figure), which is relatively large (approximately 400 μm to 500 μm), and which has a unique shape (a pattern surrounded by a dotted line in FIG. 2A, that is, a search mark), and then the pattern is registered and stored in the storage unit 11b as a pattern (a first pattern P1) detected at a low magnification (three times). In addition, although patterns, such as the workpiece mark, are clearly shown in FIG. 2A, as described above, there is a small amount of information as to the workpiece mark image, and in many cases, the pattern is hardly seen as an image at the low magnification (three times). On the other hand, since the pattern P1 (search mark) detected at the low magnification is larger than that of the workpiece mark, or its contrast thereof is high, an amount of information as to the image thereof is larger than that of the workpiece mark, so that it is relatively seen clearly.

Next, the surface of the workpiece W (FIG. 2B)) is displayed on the monitor 12 by using ten times magnification of the alignment microscope 10. The operator looks at the displayed image of the workpiece W, and searches the workpiece mark WAM that is used to perform an alignment with respect to the mask mark MAM. The size of the workpiece mark WAM is 100 μm to 150 μm. When the workpiece mark WAM (the cross mark encircled by a dotted line in FIG. 2B) is found, it is registered and stored in the storage unit 11b as a pattern (a second pattern P2) that is detected at the high magnification (ten times). Moreover, data indicating the positional relationship between the pattern P1 that is detected at the low magnification and the workpiece mark WAM that is detected at the high magnification, that is, a distance in an X-Y directions (x1, y1) of the pattern P1 and the workpiece mark WAM, is inputted in the storage unit 11b. In addition, in FIG. 2B, although the pattern of the workpiece mark WAM is relatively clearly shown, as described above, the amount of information as to the image of the workpiece mark WAM is small. However, by using the ten times magnification, it becomes possible to find it.

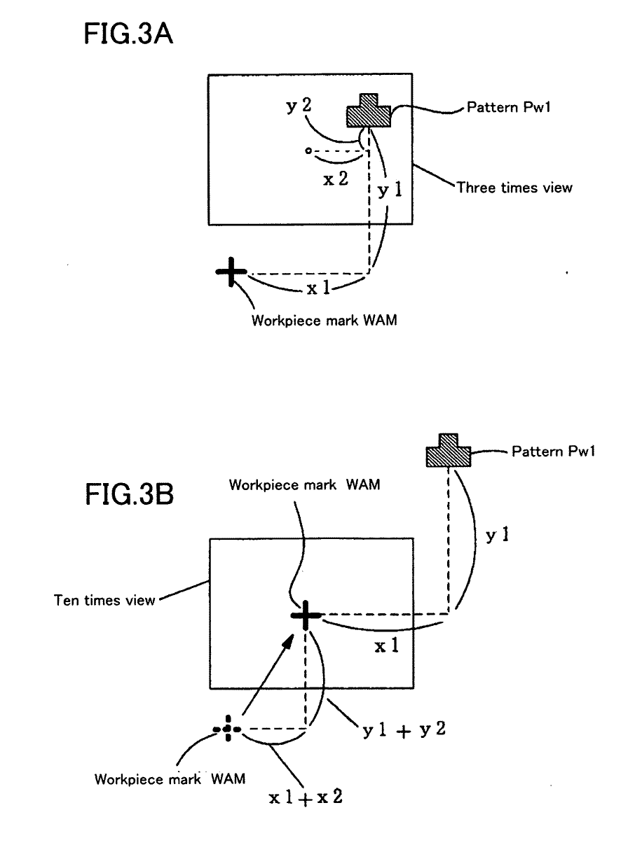

An operational procedure in case where the workpiece mark is detected in order to actually perform alignment of the mask and the workpiece, will be described below referring to FIGS. 3A, 3B, and 3C. In FIG. 1, the workpiece W to be exposed is transported onto the workpiece stage WS by a workpiece conveyance mechanism (not shown). The alignment microscope(s) 10 is inserted above the workpiece W. The control unit 11 sets the magnification of the alignment microscope 10 to three times magnification. Image information of a surface of the workpiece W is inputted in the control unit 11 from the three times magnification CCD cameras 13. The control unit 11 carries out image processing of the inputted image information by using the image processing unit 11a. The image of the surface of the workpiece W as shown in FIG. 2A, is displayed on the monitor 12. The control unit 11 reads out the first pattern P1 from a first storage section of the storage unit 11b, and searches a pattern Pw1 (a search mark), which is matched with the first pattern P1, in the three times magnification image. Since the amount of the information as to an image of the pattern Pw1 is sufficiently large, though even it is a three times magnification image, it is possible to detect it with high matching degree. The control unit 11 calculates a position coordinate (x2, y2) of the detected pattern Pw1. Namely, as shown in FIG. 3A, a position coordinate (x1, y1) of the detected pattern Pw1 is obtained by setting a screen center of the three times magnification screen view as a point of origin. Here, a distance in the X-Y directions of the workpiece mark WAM and the pattern Pw1 is represented as (x1, y1), as shown in the figure.

The control unit 11 switches the magnification of the alignment microscope(s) 10 to ten times magnification. At the same time, the workpiece stage WS is moved by a workpiece stage driving mechanism 4 so that the workpiece mark WAM may be within an image that is displayed as the ten times magnification image. The moving distance of the workpiece stage WS is calculated based on the position coordinate (x2, y2) of the pattern Pw1 detected by using the three times magnification, and the distance (x1, y1) in the X-Y directions from the stored pattern Pw1 to the workpiece mark WAM. Namely, as shown in FIG. 3B, the workpiece stage WS is moved in the X-Y directions (x1+x2, y1+y2). In this manner, the workpiece mark WAM comes to be located at approximately the center of the ten times magnification screen view. The image information of the surface of the workpiece W is inputted in the control unit 11 from the ten times magnification CCD 14, and the control unit 11 carries out image processing of the inputted image information by using the image processing unit 11a. The image of the surface of the workpiece W as shown in FIG. 2B is displayed on the monitor 12. The control unit 11 reads out the second pattern P2 from a second storage section of the storage unit 11b, and detects a pattern, which is in agreement with the pattern P2, within the ten times magnification image. That is, the workpiece mark WAM is found out, and a position coordinate thereof is calculated. Based on the calculated position coordinate of the workpiece mark WAM and the stored position coordinate of the mask mark MAM, the mask M and the workpiece W are aligned.

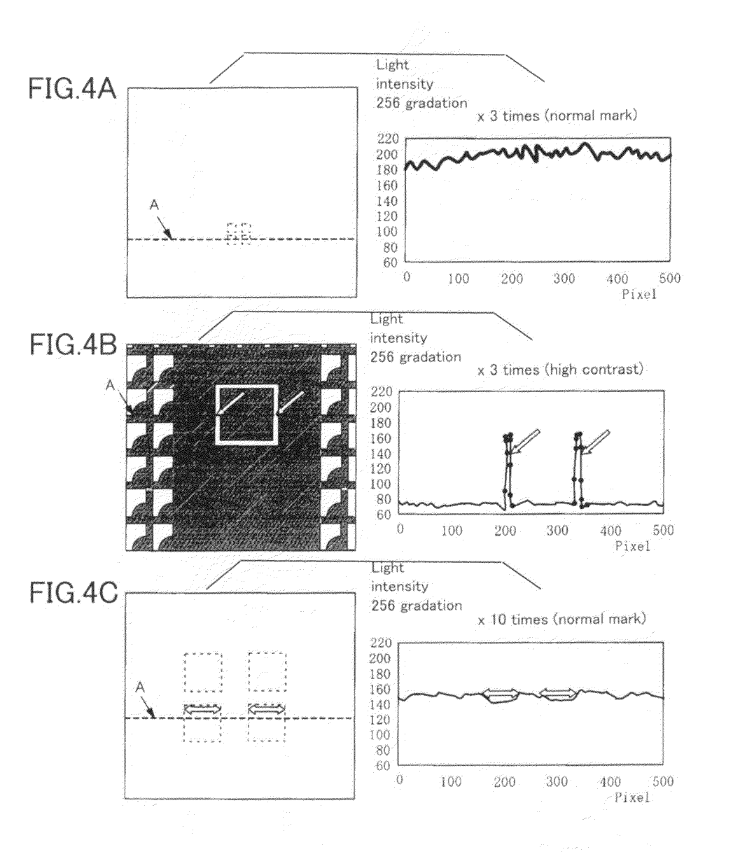

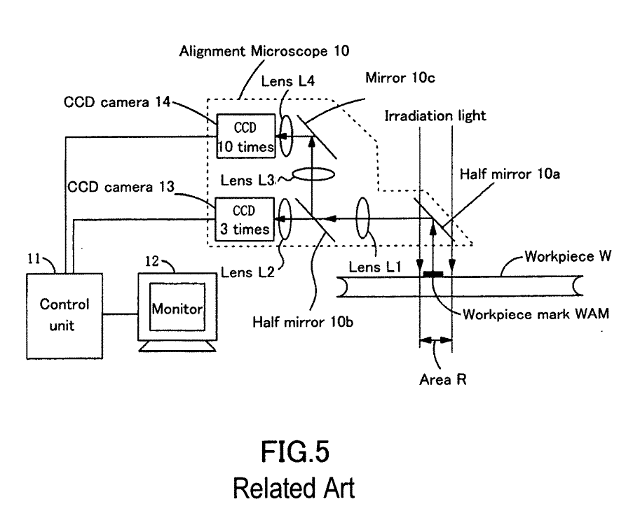

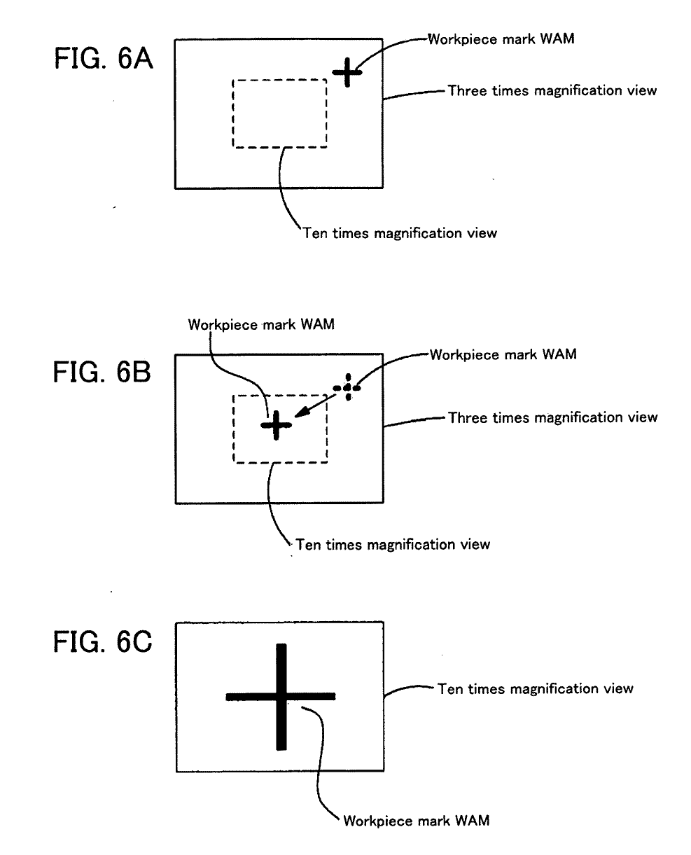

FIGS. 4A, 4B, and 4C are diagrams showing an example in case where alignment microscopes detect a transparent electrode formed on a transparent glass substrate. An image, which is detected by the alignment microscope 10, is respectively shown in a left sides of FIGS. 9A, 9B, and 4C, and a graph of the contrast of an image thereof is respectively shown in the right sides thereof. The contrast graphs in the right sides show the contrast of the image along a dotted line A in the left side of the figure. In addition, the images in the left side of FIGS. 4A, 4B, and 4C are schematically shown, wherein patterns, which are shown by dotted lines, in the left side images show patterns with low contrast, which is hardly seen. FIG. 9A shows a three times magnification image, which is obtained by detecting a pattern of a transparent electrode formed of an ITO (indium tin oxide) film on a glass substrate, and a graph that shows a contrast. Although the pattern of the electrode is formed on the glass substrate, the existence of the pattern is hardly recognized as an image, at this magnification. Moreover, as shown in the graph of the right side hand of FIG. 4A, the contrast is shown at a noise level, so that the pattern cannot be detected.

An opaque pattern made of a metal film is formed in a circumference area of the glass substrate that forms the transparent electrode, and FIG. 4B shows a three times magnification image that is obtained by detecting the pattern of the metal and a graph that shows a contrast. Thus, as long as it is the opaque metal pattern, the existence of the pattern can be clearly recognized as an image, and as shown by an arrow in the figure, the difference in contrast is clearly shown in the contrast graph in the right hand side of the figure. Thus, if the contrast thereof is high, it is possible to certainly detect the pattern. FIG. 4C shows a ten times magnification image that is obtained by detecting the transparent electrode and a graph that shows a contrast. Even if it cannot be clearly recognized as an image, as shown by an arrow in the graph in the right hand side of the figure that shows a contrast, it is possible to detect some difference in contrast thereof. As long as the contrast is at such a level, it is possible to detect that a pattern exists at this position. That is, at the ten times magnification, the pattern can be detected, even if it is transparent.

Therefore, when the opaque pattern, which is made of metal and formed in the circumference area of the glass substrate, is detected as the first pattern at the low magnification (three times), and the pattern of the transparent electrode, which is made of the ITO film, is detected as the workpiece mark at the high magnification (ten times), and further the positional relationship therebetween is acquired in advance, even if the workpiece mark is a transparent electrode, it is possible to detect them and to perform alignment of the mask and the workpiece.

The preceding description has been presented only to illustrate and describe exemplary embodiments of the present method for detecting work alignment mark and the present exposure apparatus using the same. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A method of alignment by detecting, by an alignment microscope, a mask alignment mark formed on a mask and a workpiece alignment mark formed on a workpiece and aligning a mask and a workpiece based on the detected mask alignment mark and workpiece alignment mark, comprising:
detecting a search mark formed on the workpiece by using a first magnification;
moving a workpiece stage so that the workpiece alignment mark, which is in a predetermined relative position to a position of the detected search mark, comes within a second magnification view of the alignment microscope;
switching magnification between the first magnification and a second magnification, which is higher than the first magnification; and
detecting the workpiece alignment mark by using the second magnification.

2. The method according to claim 1, wherein a size of a pattern of the search mark on the workpiece is larger than that of a pattern of the workpiece alignment mark on the workpiece.

3. The method according to claim 1 or 2, wherein a material that forms the search mark on the workpiece is different from that which forms the workpiece alignment mark on the workpiece.

4. The method according to claim 3, wherein the workpiece is transparent with respect to visible light, the search mark is an opaque pattern formed on the transparent workpiece, and the workpiece alignment mark is a transparent pattern formed on the transparent workpiece.

5. An exposure apparatus comprising:
a light emitting unit that emits exposure light;
a pattern formed in a mask;
a mask stage holding the mask;
a workpiece that is irradiated with the exposure light emitted from the light emitting unit through the mask;
a workpiece stage holding the workpiece;
an alignment microscope that detects a mask alignment mark formed on the mask and a workpiece alignment mark formed on the workpiece; and
a control unit that performs alignment of the mask and the workpiece based on a position information of the detected mask alignment mark and a workpiece alignment mark,
wherein the alignment microscope is capable of switching magnification between a first magnification and a second magnification that is higher than the first magnification,
wherein the control unit comprising:
a storage unit that stores a pattern of a search mark formed on the workpiece and a pattern of the workpiece alignment mark, and
an image processing unit that detects the search mark on the workpiece and the workpiece alignment mark by comparing the patterns of the search mark on the workpiece and the workpiece alignment mark, which were both observed by the alignment microscope, with the patterns of the search mark and the workpiece alignment mark that are stored in the storage unit,
wherein the control unit switches the magnification of the alignment microscope to the first magnification, detects the search mark formed on the workpiece, moves the workpiece stage so that the workpiece alignment mark that is in predetermined relative position with respect to a position of the detected search mark comes in a second magnification view of the alignment microscope, switches the magnification of the alignment microscope to the second magnification, and detects the workpiece alignment mark at the second magnification.
